(19) United States
(12) Patent Application Publication
(10) Pub. No.: US 2003/0188906 A1
(43) Pub. Date: Oct. 9, 2003

(54) Swing-steering system for three-wheeled vehicles

(76) Inventor: Todd Bank, Los Angeles, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/410,992

(22) Filed: Apr. 9, 2003

Related U.S. Application Data
(60) Provisional application No. 60/371,353, filed on Apr. 9, 2002.

(51) Int. Cl. B62D 61/06

(52) U.S. Cl. 180/210

(57) ABSTRACT

A three-wheeled vehicle having swing-steering includes a frame having a head tube at a front portion thereof which is disposed at an angle of between 45° and 70°. A fork is rotatably coupled to the head tube and extends downwardly therefrom at an angle of between 45° and 70°. A front wheel is attached to the fork. An elongated steering tube is coupled to the fork at a lower end thereof, and extends upwardly to a handlebar at an upper end thereof. The geometry of the vehicle allows a rider to lean into a turn and maintain the handlebars in front of the rider and the wheels on the ground.

### RELATED APPLICATION

The present application claims priority from U.S. Provisional Application Serial No. 60/371,353, filed Apr. 9, 2002.

### BACKGROUND OF THE INVENTION

The present invention generally relates to three-wheeled vehicles. More particularly, the present invention relates to a three-wheeled vehicle, sometimes referred to as a chariot-type vehicle, which incorporates a unique swing-steering design that facilitates vehicle steering.

Recently, chariot-type vehicles have found interest in designers and developers. The chariot-type vehicles are often desirable alternatives to standard transportation as they are smaller and less expensive than traditional automobiles, while granting more stability than two-wheeled motorcycles, scooters or bicycles. However, some of these chariot-vehicle designs are very complicated, rendering them expensive and generally incapable of being maintained by their owners. These complicated vehicles can also be fairly heavy and difficult to transport when broken.

The most prominent currently known chariot-vehicles utilize a steering system that is similar to standard bicycle style steering. That is, the steering on these chariots includes a bicycle handlebar and a stem or neck connecting the handlebar into a bicycle-style fork inside a head tube of the frame of the vehicle. However, this steering system does not work efficiently in three-wheeled vehicles. Whereas bicycles, motorcycles and motor scooters, having only two wheels, allow the rider to tilt the vehicle and move the rider's center of gravity through turns, the fixed bicycle-style steering does not allow such movement when incorporated into three-wheeled vehicles. This is due to the fact that the rider of the vehicle must have his or her hands in front of them while in a turn. The chariot rider shifts his or her body weight to the inside of the turn, moving their center of gravity to give them control of the vehicle. All wheels of the three-wheeled vehicle need to stay on the ground so that the vehicle is safe and stable. Using the standard bicycle style steering arrangement keeps the handlebars in the center of the chariot and not in front of the rider. Thus, although the rider may move his or her body into the turn, the hands and steering system remain in the center of the vehicle. This is awkward and inefficient and potentially dangerous.

Accordingly, there is a need for a chariot-style vehicle which is compact, lightweight and easy to maneuver. A new style of steering is necessary to allow the modern day chariot rider to lean into a turn and still remain in control by having the handlebars in front of the rider and still in the chariot's center of gravity. What is further needed is a chariot-style vehicle that is relatively simple in design and capable of collapsing for storage and transportation. The present invention fulfills these needs and provides other related advantages.

### SUMMARY OF THE INVENTION

In accordance with the above-stated needs, it is a primary object of the present invention to provide a new type of steering for a three-wheeled vehicle.

It is another object of the present invention to offer a source of transportation which is relatively light-weight so as to be easily lifted and mounted on a bike rack or lifted into a car or truck for transportation.

It is a further object of the present invention to provide an alternative source of transportation which is relatively simple in design and has few parts so as to be easily assembled and maintained by the average consumer.

It is a further object of the present invention to offer an environmentally friendly, cost-effective and easy to use alternative source of transportation or recreation.

In accordance with the objects of the present invention, a three-wheeled, stand-up vehicle that is relatively simple in design, light in weight and easily maneuvered using swing-steering is provided. Incorporation of the swing-steering renders the vehicle comfortable to ride and naturally maneuverable, while providing safety and stability to the rider.

The three-wheeled vehicle generally comprises a frame having a head tube at a front portion thereof. The head tube is disposed at an angle between 45° and 70° to enable the swing-steering. Rear wheels are rotatably attached to a rear portion of the frame. A rider support is attached to the frame, which typically comprises a platform configured to support a standing rider. A fork is rotatably coupled to the head tube and extends downwardly therefrom at an angle between 45° and 70°. A front wheel is rotatably attached to the fork. An elongated steering tube has a lower end thereof coupled to the fork, and extends upwardly to a handlebar in front of the rider. In a particularly preferred embodiment, the steering tube comprises a lower section clamped to an upper tube of the fork, and an angularly offset second section which extends upwardly to the handlebar such that the handlebar is conveniently placed in front of the rider.

A brake system is operably connected to the at least one of the wheels. The brake system includes at least one lever associated with the handlebar, with brake lines extending from the lever to a brake operably coupled to one of the wheels.

The vehicle typically includes a drive unit operably coupled to at least one wheel of the vehicle for powering the vehicle. Preferably, the drive unit comprises an electric motor so that the vehicle is environmentally friendly. Typically, the electric motor includes a drive shaft which is operatively connected to a sprocket or gear of the front wheel. An actuator is attached a handlebar and operably connected to the drive unit to selectively power the vehicle.

The vehicle is steered when a rider leans into a turn and simultaneously turns the handlebar, causing the fork to rotate and the front wheel to lean from vertical into the turn. Due to the geometry of the head tube, fork and elongated steering tube, the handlebar swings and remains in front of the rider during a turn. Thus, a rider can move his or her center of gravity into a turn while keeping the three wheels on the ground.

The vehicle of the present invention can be folded for storage or transport. This is accomplished by turning the elongated steering tube and handlebar over the frame.

Other features and advantages of the present invention will become apparent from the following more detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a front elevational view of a three-wheeled vehicle having swing-steering embodying the present invention;

FIG. 2 is a front elevational view of the vehicle of FIG. 1, illustrating a rider, in phantom, using the swing-steering of the present invention to turn the three-wheeled vehicle to the right;

FIG. 3 is a front elevational view of the vehicle of FIG. 1, depicting a rider, in phantom, using the swing-steering of the present invention to turn the vehicle left;

FIG. 4 is a side elevational view of a three-wheeled vehicle embodying the present invention;

FIG. 5 is a side elevational view similar to FIG. 4, illustrating an elongated steering tube and handlebar thereof rotated into a storage position;

FIG. 6 is an enlarged, partially fragmented and exploded perspective view taken generally of area “6” of FIG. 4, illustrating a means for clamping the fork, head tube and steering tube of the vehicle of the present invention;

FIG. 7 is a partially fragmented and exploded perspective view of another clamping assembly used in accordance with the present invention for connecting the fork and steering tube to the head tube; and

FIG. 8 is an enlarged and partially sectioned view of area “8” of FIG. 1, illustrating the operable coupling of a sprocket of a front wheel vehicle and a drive unit of the vehicle.

### DETAILED DESCRIPTION OF THE PREFERRED EMBODIMENTS

As shown in the drawings for purposes of illustration, the present invention is concerned with a three-wheeled, stand-up, chariot-style vehicle utilizing a swing-steering design.

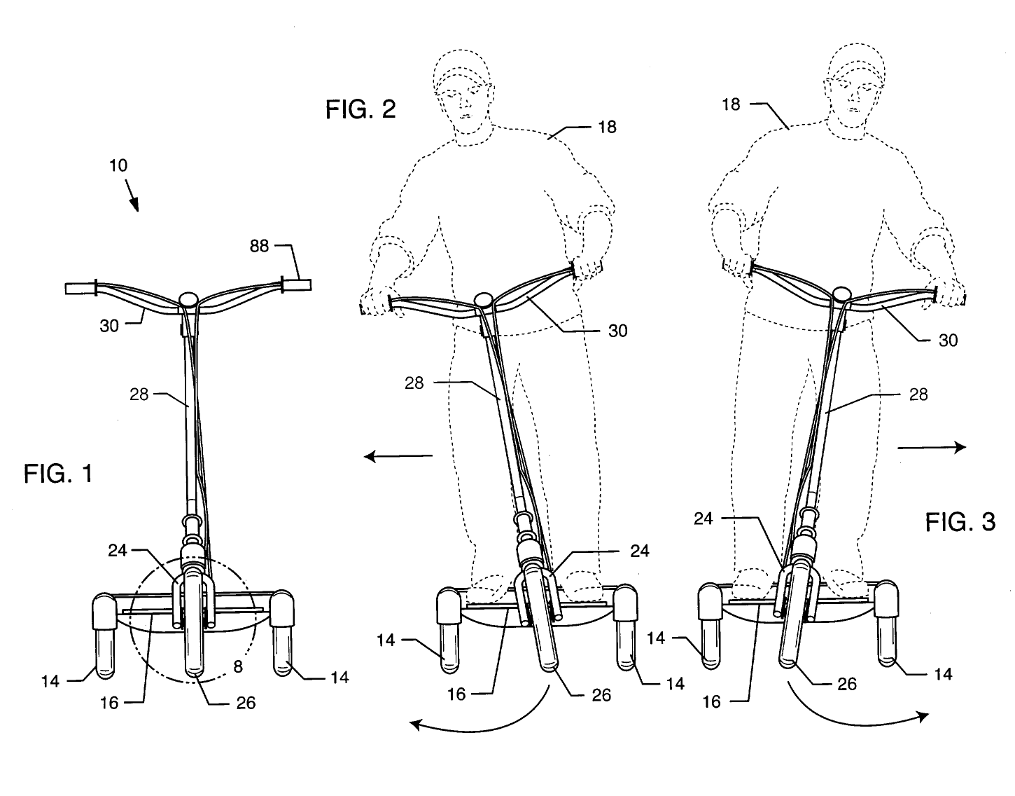

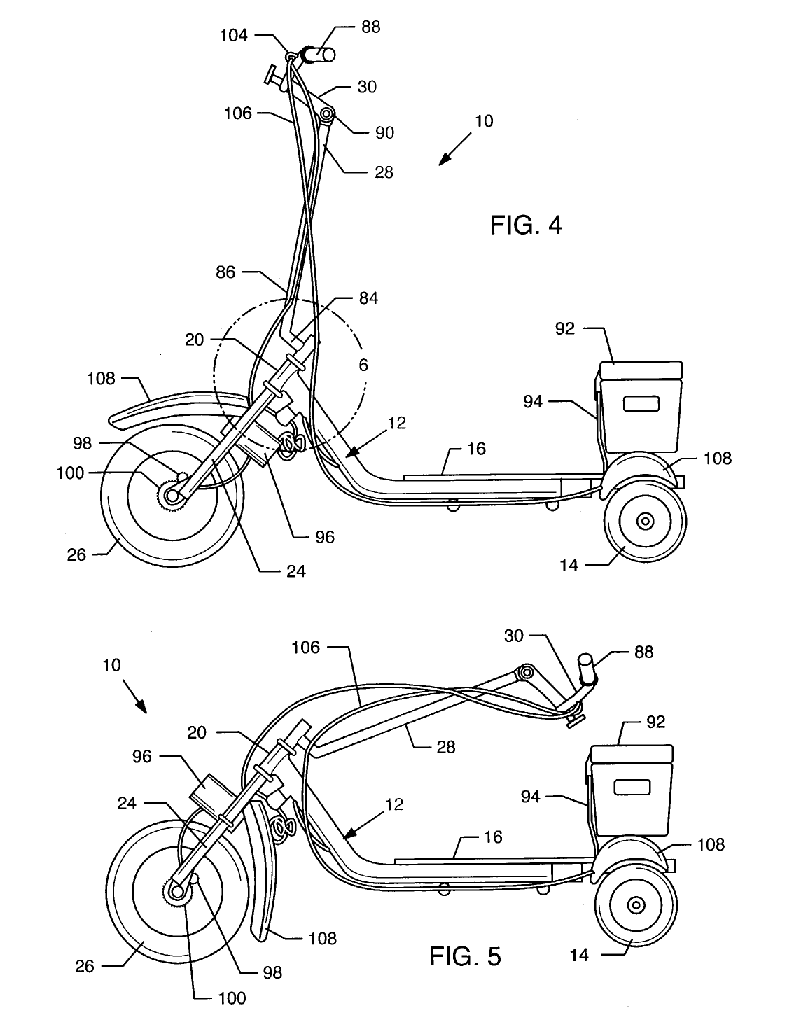

With reference now to FIGS. 1 and 4, the vehicle, generally referred to by the reference number 10, includes a frame 12 which is comprised of any material that is strong enough to support a relatively heavy rider. Steel, aluminum and carbon fiber tubing have been found to provide sufficient structural support while being relatively light in weight. The frame 12 can be a mono main tube, or there can be two or more tubes or composites for extra strength. It is contemplated by the present invention that the frame 12 be in two sections to lengthen the vehicle 10.

Two rear wheels 14 are rotatably attached to a rear end of the frame 12. The rear wheels 14 may be connected to the frame 12 by any well-known means, including the insertion of an axle extending between the rear wheels 14 and through end portions of the frame 12. Each rear wheel 14 may include its own axle.

A rider support 16 is attached to the frame 12. Typically, the rider support 16 comprises a generally planar platform which supports the rider as he or she stands and operates the vehicle 10. The platform 16 may include non-slip surfaces so that the rider 18 does not slip in wet conditions.

The frame 12 slopes upwardly at a front end portion of the vehicle 10 to a head tube 20. The head tube 20 is disposed at an angle off vertical to accomplish the swing-steering of the present invention. More particularly, the head tube is disposed at an angle of between 45° and 70°. In a particularly preferred embodiment, the head tube 20 is disposed at an approximately 55° angle.

An upper tube 22 of a standard bicycle fork 24 (such as a BMX or mountain bike) is inserted into the head tube 20 such that the fork 24 extends downwardly from the head tube 20 at approximately the same angle, generally between 45° and 70°. A standard bicycle head set, as will be described more fully herein, offers roller bearings that allow the fork 24 to rotate. A single front wheel 26 is rotatably attached to a lower end of the fork 24. This can be accomplished by any one of traditional means, including having an axle of the front wheel 26 slip into apertures of the fork tabs. A nut on each side locks the wheel onto the fork 24. A front wheel quick release system, such as those used in mountain bikes, can be incorporated such that the wheel 26 can be removed from the fork 24 to allow the front wheel to be repaired, replaced, etc.

An elongated steering tube 28 has a lower end thereof clamped to the fork upper tube 22 at the head tube 20. The elongated steering tube 28 is typically between two feet and four feet in length such that handlebars 30 attached at an upper end of the steering tube 28 are positioned at approximately the mid section of the rider 18.

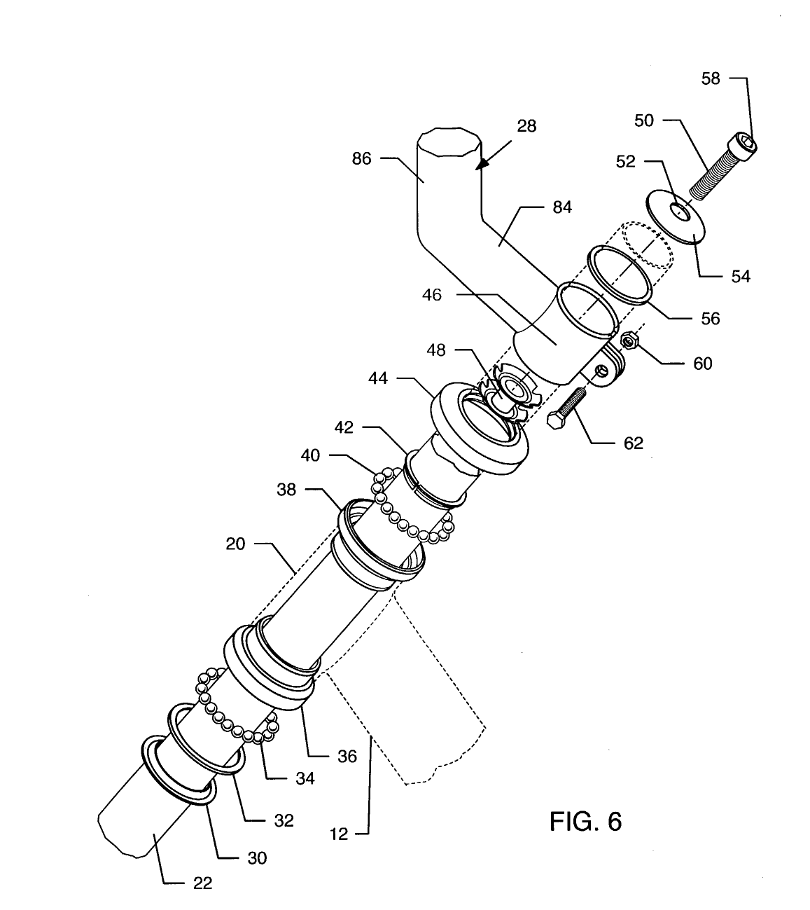

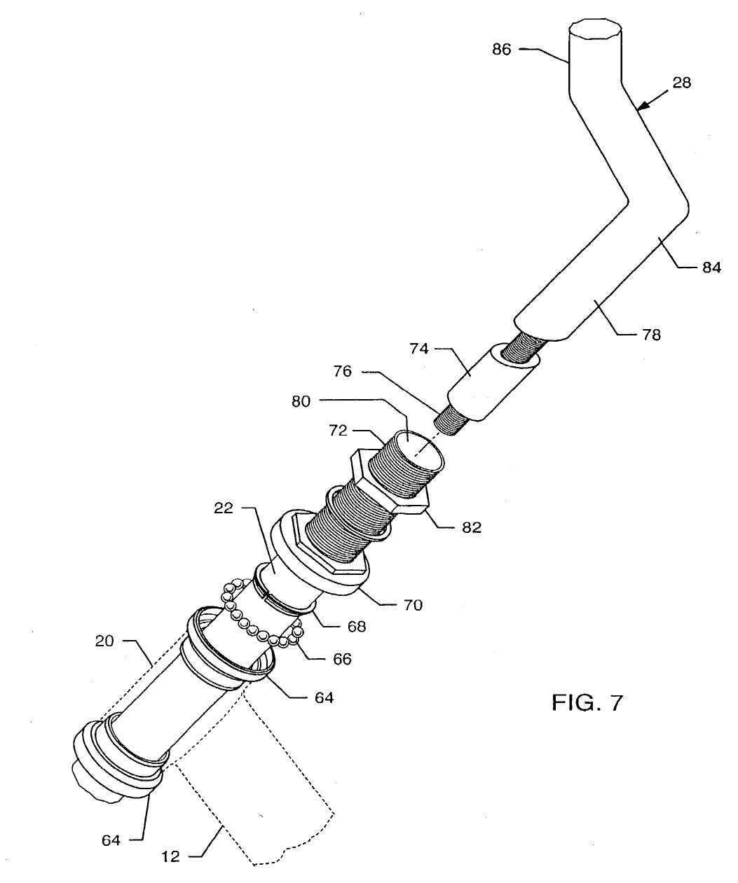

With reference now to FIG. 6, a head set supports the upper forked tube 22 in the center of the head tube 20 similar to standard bicycle technology. A bicycle stem clamp, such as the threadless head set illustrated in FIG. 6, may be used to clamp the steerer tube 22 of the bicycle fork 24 to the head tube 20 and lower end of the steering tube 28. Such head sets or clamps are typically offered in two varieties, illustrated in FIGS. 6 and 7. FIG. 6 illustrates a threadless head set having a lower crown race 30 which engages in lower seal 32 which seals bearings 34 within a lower bearing cup 36. A similar assembly engages the steerer tube 24 above the head tube 20. Such assembly consists of an upper bearing cup 38 holding bearings 40 which are held in place with a compression ring 42. An upper bearing cover 44 seals and protects the bearings 40 and lubricant. The upper end of the steerer tube 22 of the fork 24 is attached to the lower end 46 of the steering tube 28 by means of a star nut 48 which is inserted into the end of the fork tube 22 and which is internally threaded so as to engage a compression bolt 50 which extends through the lower end 46 of the steering tube 28. The compression bolt 50 extends through an aperture 52 of a top cap 54 which can rest on a spacer or washer 56 at an upper edge of the lower clamping end 46 of the steering tube. The compression bolt 50 includes a drive nut recess 58 which can accept a tool, such as an Allen wrench or screwdriver. Once the upper steerer tube 22 of the fork is inserted and fastened into place in the head tube 20, the compression bolt 50 is tightened to join the steering tube 28 to the fork 24. In such arrangements, the lower end 46 of the steering tube 28 is typically formed as a C-clamp or circular clamp which is received over the end of the fork tube 22. A nut 60 and bolt 62 may be used to tighten this connection.

With reference now to FIG. 7, a second commonly used bicycle head set clamp assembly is illustrated which is used in accordance with the present invention. Bearing assemblies 64 including bearings 66, a retainer seal 68 and cover 70 are used to fasten the upper fork tube 22 to the head tube 20 such that it is centered therein and can freely rotate.

Nut 82 is tightened to compress cover 70 onto the base 64 so that the upper tube 22 of the fork 24 is securely held in place. The reader will note that the end 72 of the steerer tube 22 is externally threaded. This is for accepting a wedge and bolt clamping system. As such, a wedge member 74 is threadedly connected to a bolt 76 extending through a lower end 78 of the steering tube 28. The wedge 74 and bolt 76 are inserted into the open end 80 of the steerer tube 22. A drive nut end (not shown) of bolt 76 is then tightened, such as with an Allen wrench or screwdriver, to fasten the steering tube 28 and fork tube 22 to one another.

It will be appreciated by those skilled in the art that FIGS. 6 and 7 merely illustrate two of the more commonly used head set and clamping systems in the bicycle art. Although it is advantageous to use such off-the-shelf components for easy assembly and repair, it will be appreciated by those skilled in the art that any other means of attaching the steering tube 28 to the forks 24 at the appropriate angle such that turning the handlebars 30 translates into rotation and turning of the wheel 26 of the vehicle 10.

With reference again to FIGS. 1 and 4, the steering tube 28 can be of varying lengths to allow various sized riders. The tube 28 is preferably very strong to allow upper body support and resist breakage due to the forces that are applied thereto. As shown in the various figures, the elongated steering tube 28 is preferably comprised of a lower portion 84 which is angled such so as to be attached to the upper fork tube 22 and an upper section 86 which is angularly offset from the lower section 84 for properly positioning the handlebars 30 at a comfortable and convenient location in front of the rider 18. The steering tube 28 acts as a shock absorber to the handlebars 30 due to its configuration. This is due to the fact that the steering tube 28 is at an angle with respect to the handlebars 30 and front wheel 26 such that force is applied to the front wheel while riding the vehicle 10 are not transmitted directly upwardly into the handlebars 30 as with bicycles or traditional three-wheeled vehicles.

The handlebars 30 may be of various designs and include hand grips 88 at ends thereof for comfort of the user. The handlebar 30 may be connected to an upper end of the steering tube 28 by a stem 90 which allows the handlebars 30 to be adjusted to a comfortable position for the individual rider. Alternatively, the handlebars 30 may be welded to the steering tube 28.

Due to the arrangement of tubes and parts of the steering system, and its offset angles, the motions of the steering tube 28 as it is moved left and right in a generally semi-circular arc is unique to the present invention. As shown in FIGS. 2 and 3, the rider 18 is able to lean his or her body into the turn and swing the handlebars 30 into the turn as well such that the handlebars 30 remain generally in front of the rider 18 throughout the turn. Turning/swinging the handlebars 30 rotates the elongated steering tube 28, which in turn, rotates forks 24. This causes the front wheel 26 to actually turn and lean into the turn, as illustrated. This “tracking” is similar to the movements of a bicyclist or motorcycle rider and promotes stability. The rider 18 is able to lean into the turn, similar to a snow skier, without fear that the wheels 14 and 26 will leave the riding surface. The steering system of the present invention also allows the steering tube 28 and handlebar 30 to remain close to the rider 18 as he or she leans into a turn. This allows the rider 18 to make sharper turns than otherwise possible and also results in increased stability than that offered by prior chariot-style vehicles as the body weight remains over both the front 26 and rear inner wheel 14 during the turn. The swing-steering also promotes confidence in the rider 18 as he or she is not impeded in their natural movements during a turn.

The vehicle 10 can be human-powered, wherein the rider 18 propels the vehicle 10 by pushing off with his or her feet repetitively in a manner similar as a skateboard. Alternatively, a drive unit, such as a combustion engine can be used to drive one or more of the wheels 26 and 14. However, with the increasing concern of oil depletion, air pollution, noise pollution, and the relatively new requirements that the minimum number of vehicles make no-emissions, the vehicle 10 of the present invention is particularly adapted for use as an electric vehicle.

With reference now to FIGS. 4, 5 and 8, a battery pack 92 is mounted onto the vehicle 10. An electric lead 94 extends from the battery 92 to an electric motor 96. Typically, the electric motor 96 is fastened to a front fork 24 adjacent to the front wheel 26. However, the present invention is not limited to such as the motor 96 can operably be coupled to one or more of the rear wheels 14.

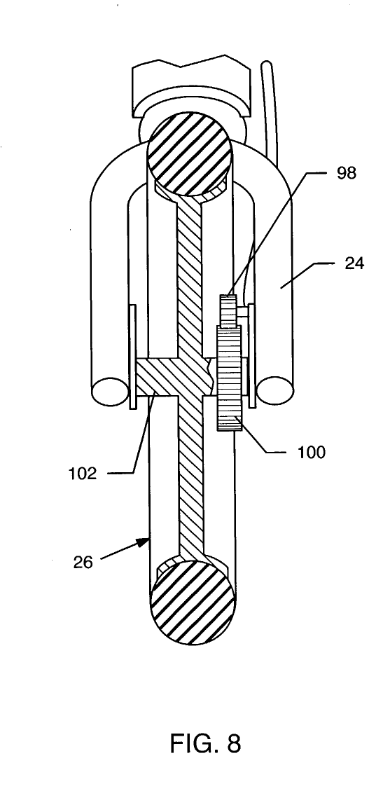

The electric motor 96 can be operatively connected to the front wheel 26 to drive the same in many manners. With reference to FIG. 8, a drive gear 98 of the electric motor 96 is engaged with a sprocket 100 of an axle 102 of the front wheel 26. Thus, as the electric motor 96 is powered, drive gear 98 rotates, causing the sprocket 100 and axle 102 to rotate the front wheel 26. The motor sprocket 98 can also be aligned with a free wheel sprocket on the front wheel with a chain interconnecting the sprockets in order to drive the front wheel 26. Of course, those skilled in the art will appreciate that there are other means of electrically powering the vehicle 10.

An actuator, such as a throttle, is typically attached to the handlebar 30 for easy access by the rider 18. Actuating the throttle causes power to be delivered to the motor 96 for driving the front wheel 26.

The vehicle 10 also preferably includes a brake system comprised of a lever 104 positioned adjacent to the hand grips 88 having a brake cable 106 extending therefrom to a brake (disk or standard bicycle caliper) associated with one or more of the wheels 14 and 26 for braking purposes.

Various improvements can be made, and accessories added, to the chariot-style vehicle 10 to meet the needs of the consumer. These include mud guards 108 or ferrings about the wheels, enlarged wheels, turn signals, reflectors, lights, etc. Water bottle cages, key switches, locking steering or cable locks prevent theft, headlights for operation at night, etc. may also be implemented. The battery pack 92 may be secured to the frame 12 of the vehicle 10, and removable so as to be easily charged and prevent theft. The vehicle 10 may also be incorporated into an off-road style vehicle which would be modified to have the necessary wheels for operation. A more powerful electric motor may also be incorporated into this design.

As will be appreciated by the reader, the present invention provides a steering system that is designed so that anyone can steer the vehicle much easier than fixed steering systems. This makes the vehicle easier, more comfortable and safer to ride. Also, the vehicle can travel at faster speeds due to the enhanced turning. The vehicle may serve either recreational or mass transmit purposes. As described above, the chariot can have baskets to carry groceries, books, lunches, tools and other items. Due to its relatively light weight, the vehicle can be carried upstairs and fit into a elevator or on the subway. The vehicle of the present invention may find particular use for police departments, city workers, warehouse workers, as well as the typical consumer. The use of the electric motor to drive the vehicle renders the vehicle quiet and non-polluting.

Although several embodiments of the present invention have been described in detail for purposes of illustration, various modifications of each may be made without departing from the spirit and scope of the invention. Accordingly, the invention is not to be limited, except as by the appended claims.

What is claimed is:

1. A three-wheeled vehicle having swing-steering, the vehicle comprising:
a frame having a head tube at a front portion thereof, the head tube being disposed at an angle of between 45 degrees and 65 degrees;
rear wheels rotatably attached to a rear portion of the frame;
a rider support attached to the frame;
a fork rotatably coupled to the head tube and extending downwardly therefrom at an angle of between 45 degrees and 70 degrees;
a front wheel rotatably attached to the fork; and
an elongated steering tube having a lower end thereof coupled to the fork, and extending upwardly to a handlebar;
wherein the vehicle is steered when a rider leans into a turn and simultaneously turns the handlebar, causing the fork to rotate and the front wheel to lean from vertical; and
wherein the handle bar swings and remains in front of the rider during a turn.

2. The vehicle of claim 1, including a drive unit operably coupled to at least one wheel of the vehicle for powering the vehicle.

3. The vehicle of claim 2, wherein the drive unit includes an electric motor.

4. The vehicle of claim 3, wherein the electric motor includes a drive shaft operably connected to a sprocket of the front wheel.

5. The vehicle of claim 2, including an actuator attached to the handlebar and operably connected to the drive unit to selectively power the drive unit.

6. The vehicle of claim 1, including a brake system operably connected to at least one of the wheels.

7. The vehicle of claim 6, wherein the brake system comprises at least one lever associated with the handlebar and having brake lines extending to a brake operably coupled to at least one of the wheels.

8. The vehicle of claim 1, wherein the rider support comprises a platform configured to support a standing rider.

9. The vehicle of claim 1, wherein the steering tube comprises a first lower section clamped to an upper tube of the fork, and an angularly offset second section which extends upwardly to the handlebar.

10. The vehicle of claim 1, wherein the elongated steering tube and handlebar can be turned over the frame for storage or transport.

11. A three-wheeled vehicle having swing-steering, the vehicle comprising:
a frame having a head tube at a front portion thereof, the head tube being disposed at an angle of between 45 degrees and 70 degrees;
rear wheels rotatably attached to a rear portion of the frame;
a rider support platform attached to the frame and configured to support a standing rider;
a fork rotatably coupled to the head tube and extending downwardly therefrom at an angle of between 45 degrees and 70 degrees;
a front wheel rotatably attached to a lower end of the fork;
an elongated steering tube having a lower end thereof coupled to the fork, and extending upwardly to a handlebar;
a drive unit operably coupled to at least one wheel for powering the vehicle;
an actuator connected to the drive unit; and
a brake system connected to at least one of the wheels;
wherein the vehicle is steered when a rider leans into a turn and simultaneously turns the handlebar causing the fork to rotate and the front wheel to lean from vertical; and
wherein the handle bar swings and remains in front of the rider during a turn.

12. The vehicle of claim 11, wherein the drive unit comprises an electric motor.

13. The vehicle of claim 11, wherein the electric motor includes a drive shaft operably connected to a sprocket of the front wheel.

14. The vehicle of claim 11, wherein the brake system comprises at least one lever associated with the handlebar and having brake lines extending to a brake operably coupled to at least one of the wheels.

15. The vehicle of claim 11, wherein the steering tube comprises a first lower section clamped to an upper tube of the fork, and an angularly offset second section which extends upwardly to the handlebar.

16. The vehicle of claim 11, wherein the elongated steering tube and handlebar can be turned over the frame for storage or transport.

17. A three-wheeled vehicle having swing-steering, the vehicle comprising:
a frame having a head tube at a front portion thereof, the head tube being disposed at an angle of between 45 degrees and 70 degrees;
rear wheels rotatably attached to a rear portion of the frame;
a rider support platform attached to the frame and configured to support a standing rider;
a fork rotatably coupled to the head tube and extending downwardly therefrom at an angle of between 45 degrees and 70 degrees;
a front wheel rotatably attached to a lower end of the fork;
an elongated steering tube having a lower end thereof coupled to the fork, and extending upwardly to a handlebar;
an electric motor having a drive shaft operably coupled to a sprocket of the front wheel for powering the vehicle;
an actuator attached to the handlebar and connected to the electric motor for selectively powering the motor; and
a brake system comprised of a lever connected to the handlebar and having a brake line extending to a brake operably coupled with at least one of the wheels;
wherein the vehicle is steered when a rider leans into a turn and simultaneously turns the handlebar causing the fork to rotate and the front wheel to lean from vertical; and
wherein the handle bar swings and remains in front of the rider during a turn.

18. The vehicle of claim 17, wherein the steering tube comprises a first lower section clamped to an upper tube of the fork, and an angularly offset second section which extends upwardly to the handlebar.

19. The vehicle of claim 17, wherein the elongated steering tube and handlebar can be turned over the frame for storage or transport.
